(19) United States
(12) Patent Application Publication
(10) Pub. No.: US 2007/0052205 A1
(43) Pub. Date: Mar. 8, 2007

(54) Device and method for aligning a trailer hitch

(76) Inventor: James Sass, Quincy, IL (US)

Correspondence Address: PERKINS COIE LLP, P.O. BOX 2168, MENLO PARK, CA, 94026, US

(21) Appl. No.: 11/517,822

(22) Filed: Sep. 7, 2006

Related U.S. Application Data
(60) Provisional application No. 60/715,401, filed on Sep. 7, 2005.

(51) Int. Cl. B60D 1/36

(52) U.S. Cl. 280/477; 280/491.1

(57) ABSTRACT

A technique for aligning a trailer hitch tube and a trailer hitch is disclosed. A device according to the technique includes a hitch stop. In one embodiment, the hitch stop is substantially square and hollow. The hitch stop can have a hole for a set screw. The hitch stop can be fastened to the trailer hitch tube by tightening the set screw while the hitch stop is on the trailer hitch tube.

### CROSS-REFERENCE TO RELATED APPLICATIONS

This Application claims the benefit of U.S. Provisional Application No. 60/715,401 entitled “Hitch Tube Stop Collar” by James Sass filed on Sep. 7, 2005, which is incorporated by reference.

### BACKGROUND

In order to connect a conventional trailer to a vehicle, a trailer hitch tube must be inserted into a trailer hitch. The trailer hitch tube must be inserted in precisely the correct position to align hitch pin holes found on the trailer hitch tube and the trailer hitch. Typically, the alignment of hitch pin holes is a tedious task as misalignment often occurs due to over penetration or under penetration of the trailer hitch tube in the trailer hitch.

What is needed is a device and method for aligning trailer hitch pin holes in an easy and efficient manner. What is further needed is a device that can be fastened to a trailer hitch tube to facilitate the alignment of the trailer hitch tube and the trailer hitch on a reoccurring basis.

The foregoing examples of the related art and limitations related therewith are intended to be illustrative and not exclusive. Other limitations of the related art will become apparent to those of skill in the art upon a reading of the specification and a study of the drawings.

### SUMMARY OF THE INVENTION

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for aligning a trailer hitch tube and a trailer hitch involves a device for aligning hitch pin holes on the trailer hitch tube and the trailer hitch. An example of a device according to the technique includes a hitch stop. In one embodiment, the hitch stop is substantially square and hollow. The hitch stop can have a hole for a set screw. The hole can have a top end located in an outer square portion of the hitch top and a bottom end located in an inner square portion of the hitch stop. Following the embodiment, the hitch stop can be fastened to the trailer hitch tube by tightening the set screw while the hitch stop is on the trailer hitch tube.

In additional embodiments, the hitch stop can be made from mechanical steel tubing, metal, rubber, plastic, or any other equivalent composition suitable for aiding in the aligning of a trailer hitch tube and trailer hitch. In other embodiments, the set screw can be made from stainless steel, metal, rubber, plastic, or any other equivalent composition suitable for locking the hitch stop in place.

In certain embodiments, the hitch stop can be suitable for sliding on a trailer hitch tube that is 2 square inches. Further, the hitch stop can be approximately 0.315 inches thick. In other embodiments, the hitch stop can have a border that is approximately 0.25 inches. The hole, in additional embodiments, can be 0.25 inches deep and the set screw can be 0.25 inches long.

An example of a method according to the technique involves placing a hitch stop on a trailer hitch tube. In certain embodiments, the hitch stop can be substantially square and hollow with a hole for a set screw. In other embodiments, the hitch stop can be a variety of shapes and sizes such as a circle, rectangle, trapezoid, or any other shape or size capable of aligning a trailer hitch tube with a trailer hitch.

Continuing with the example, the trailer hitch tube can be inserted into a trailer hitch. The trailer hitch tube and the trailer hitch can have hitch pin holes. Once the hitch pin holes are aligned, a hitch pin can be inserted. The hitch stop can be slid against the hitch and locked in place by tightening the set screw.

Since the hitch stop is now in place, the effort and precision associated with aligning the hitch pin holes is greatly diminished. For instance, if the trailer hitch tube is removed from the trailer hitch and reinserted, the hitch stop will cause the hitch tube to stop precisely where the hitch pin holes are aligned. The hitch pin can then be inserted with only a minimal effort required by the operator of the trailer and/or trailer hitch.

The proposed device and method can offer, among other advantages, a mechanism for aligning a trailer hitch tube and a trailer hitch. Advantageously, the device and method can facilitate the aligning of hitch pin holes by locking a hitch stop in an appropriate location on the trailer hitch tube. When the trailer hitch tube is inserted into the trailer hitch with the hitch stop in place, the hitch stop can prevent the hitch tube from further penetration when the hitch pin holes are aligned. These and other advantages of the present invention will become apparent to those skilled in the art upon a reading of the following descriptions and a study of the several figures of the drawings.

### BRIEF DESCRIPTION OF THE DRAWINGS

Embodiments of the inventions are illustrated in the figures. However, the embodiments and figures are illustrative rather than limiting; they provide examples of the invention.

FIG. 1 depicts a side view of an example of a device for aligning a trailer hitch and a trailer hitch tube.

FIG. 2 depicts a top view of an example of a device for aligning a trailer hitch and a trailer hitch tube.

FIG. 3 depicts an example of a system for setting a device for aligning a trailer hitch and a trailer hitch tube.

FIG. 4 depicts an example of a system for aligning a trailer hitch and a trailer hitch tube.

FIG. 5 depicts a perspective view of an example of a device for aligning a trailer hitch and a trailer hitch tube.

### DETAILED DESCRIPTION OF THE DRAWINGS

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

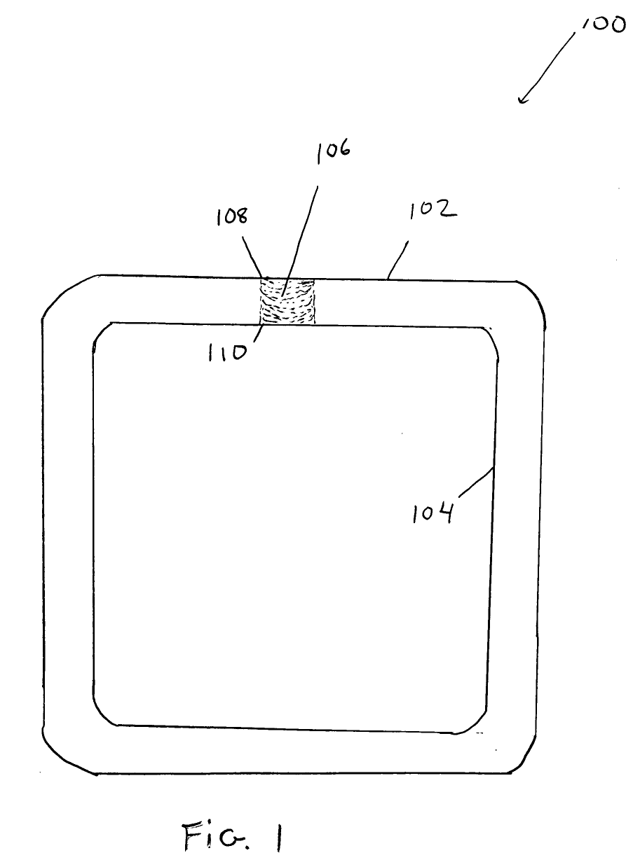

FIG. 1 depicts an example of a device 100 for aligning a trailer hitch tube and a trailer hitch. In the example of FIG. 1, the device 100 is a hitch stop and is shown from a side view. As shown in the example of FIG. 1, the hitch stop 100 is hollow and substantially square. The hitch stop has an outer square region 102 and an inner square region 104. The hitch stop also has a hole 106 with a top 108 and a bottom 110. In the example of FIG. 1, the top of the hole 108 is located in the outer square portion 102 while the bottom of the hole 110 is located in the inner square region 104.

In the example of FIG. 1, the hitch stop 100 is capable of sliding on to a trailer hitch tube. The hitch stop 100 is also capable of locking in place on the trailer hitch tube by tightening a set screw (not shown) in the hole 106. The set screw can be part of the hitch stop 100 and irremovable or can be inserted into hole 106 and removable. In other embodiments, the hitch stop 100 can be any convenient and/or known shape, including but not limited to a circle, rectangle, trapezoid, octagon, triangle, polygon, or any other shape capable of aligning a trailer hitch tube and a trailer hitch. Further, the hitch stop 100 can be any convenient and/or known material, including but not limited to metal, rubber, plastic, or any other material suitable for aligning a trailer hitch tube and trailer hitch.

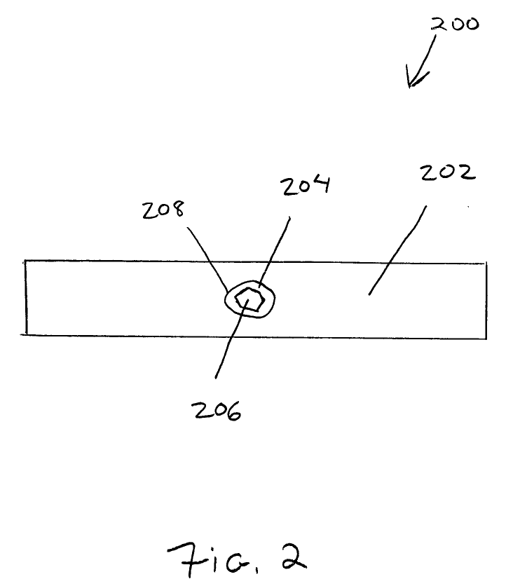

FIG. 2 depicts an alternate view of example of a device 200 for aligning a trailer hitch tube and a trailer hitch. In the example of FIG. 2, the device 200 is a hitch stop and is shown from a top view. As shown in the example of FIG. 2, an outer square portion 202 has a hole 204 for a set screw 206. The top portion of the hole 208 is located in the outer square portion 202. In operation, the set screw 206 can be tightened while the hitch stop 200 is on the trailer hitch tube.

In the example of FIG. 2, the set screw 206 is made from stainless steel. In other embodiments, the screw can be made from metal, rubber, plastic, or any other convenient and/or known material suitable for locking the hitch stop 200 in place. In alternate embodiments, the set screw 206 can be removable and/or non-removable. Further, in additional embodiments, the set screw 206 can be replaced with a pin, nail, tack, or any other convenient and/or know mechanism suitable for locking the hitch stop in place.

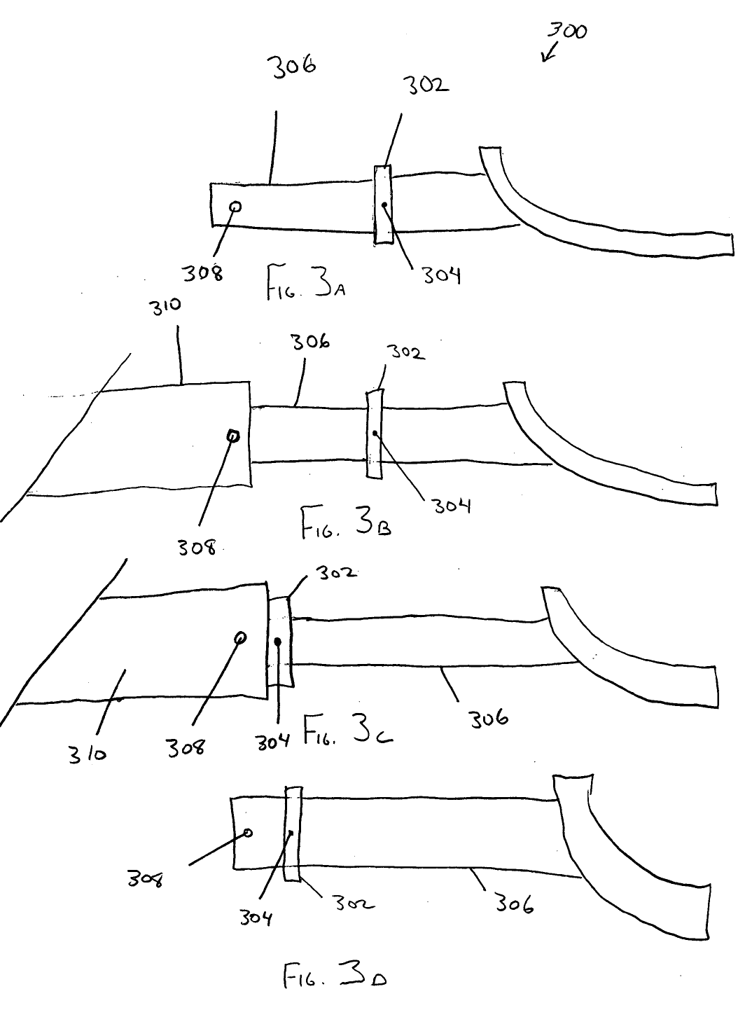

FIG. 3 depicts an example of a system 300 for setting a device for aligning a trailer hitch and a trailer hitch tube. As shown in the example of FIG. 3, the system 300 includes a device 302 for aligning a trailer hitch and trailer hitch tube, a fastening device 304, a trailer hitch tube 306, hitch pin holes 308, and a trailer hitch 310.

In operation, as shown in FIG. 3a, the device 302 for aligning is placed on the trailer hitch tube 306. In FIG. 3b, the trailer hitch tube 306 is then inserted into the trailer hitch 310 and the hitch pin holes 308 are aligned. In certain embodiments, a hitch pin can be inserted into the hitch pin holes 308 to secure alignment. In FIG. 3c, the device 302 for aligning is slid against the trailer hitch 310. The device 302 is then secured in place by the fastener 304. Thus, the device 302 now marks the position that facilitates alignment of the hitch pin holes 308. In FIG. 3d the trailer hitch tube 306 is removed from the trailer hitch 310 and the device 302 for aligning remains in order to aid in the alignment of hitch pin holes 308 during subsequent connections. If a hitch pin is used to secure alignment, the hitch pin can be removed in order to remove the trailer hitch tube 306 from the trailer hitch 310.

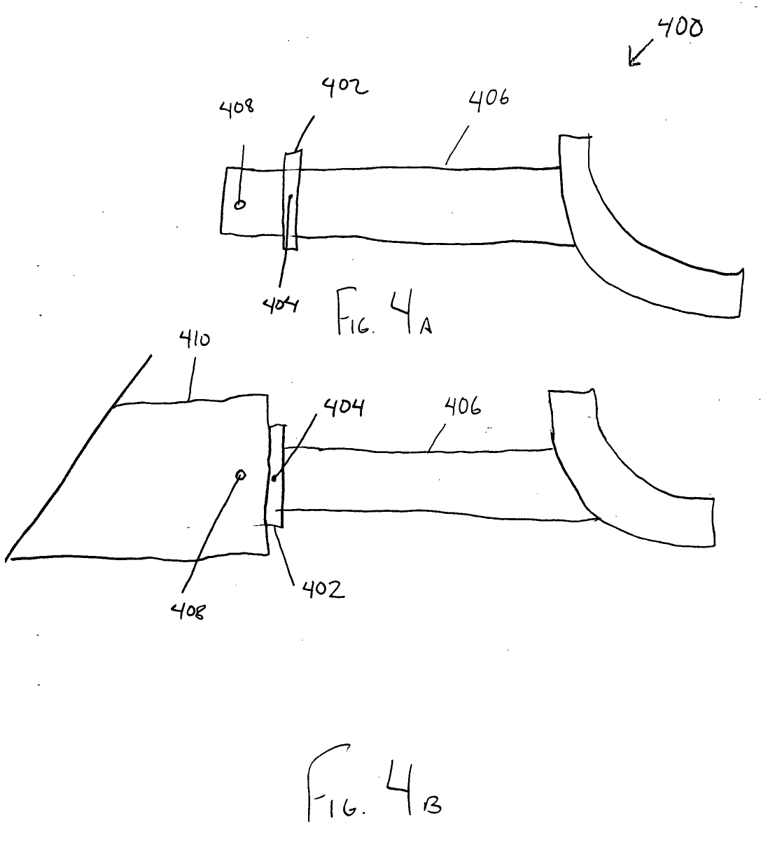

FIG. 4 depicts an example of a system 400 for aligning a trailer hitch and a trailer hitch tube. As shown in the example of FIG. 4, the system 400 include a device 402 for aligning a trailer hitch and trailer hitch tube, a fastening device 404, a trailer hitch tube 406, a hitch pin hole 408, and a trailer hitch 410.

In the example of FIG. 4a, the device 402 for aligning is attached to the trailer hitch tube 406 by the fastening device 404. The device 402 has been previously set in place to facilitate easy alignment of the hitch pin holes 408. In FIG. 4b, the trailer hitch tube 406 is inserted into the trailer hitch 410. The device 402 prevents the trailer hitch tube 406 from further penetration into the hitch 410 thereby easily aligning the hitch pin holes 408. A hitch pin can now be inserted into the hitch pin holes 408.

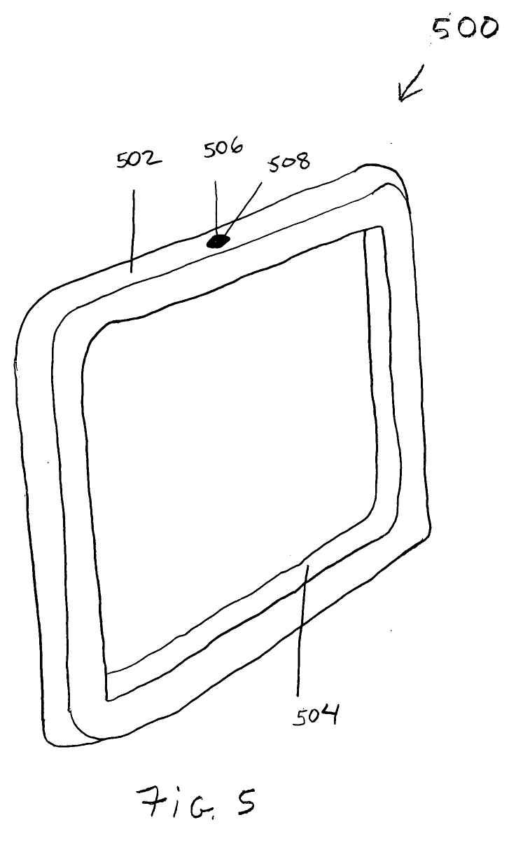

FIG. 5 depicts an alternate example of a device 500 for aligning a trailer hitch tube and a trailer hitch. In the example of FIG. 5, the device 500 is a hitch stop and is shown from a perspective view. As shown in the example of FIG. 5, the hitch stop 500 is hollow and substantially square. The hitch stop 500 has an outer square region 502 and an inner square region 504. The hitch stop also has a hole 506 with a top 508 and a bottom (not shown). In the example of FIG. 5, the top of the hole 508 is located in the outer square portion 502 while the bottom of the hole (not shown) is located in the inner square region 504. In the example of FIG. 5, the hole 506 is suitable for the insertion of a set screw or any convenient and/or known mechanism capable of locking the hitch stop 500 in place.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

1. An apparatus for aligning a trailer hitch tube and a trailer hitch, the apparatus comprising:
a hitch stop that is substantially square and hollow, the hitch stop having an outer square portion and an inner square portion, the hitch stop being capable of sliding onto a trailer hitch tube,
a hole for a set screw, the hole having a top end and a bottom end, the top end of the hole being located in the outer square portion and the bottom end of the hole being located in the inner square portion,
wherein the hitch stop is capable of being fastened to the trailer hitch tube by tightening the set screw while the hitch stop is on the trailer hitch tube.

2. An apparatus as recited in claim 1, wherein the hitch stop is made from one in the group consisting of mechanical steel tubing, metal, rubber and plastic.

3. An apparatus as recited in claim 2, wherein the set screw is made from one in the group consisting of stainless steel, metal, rubber and plastic.

4. An apparatus as recited in claim 1, wherein the set screw cannot be removed from the hole.

5. An apparatus as recited in claim 1, wherein the set screw can be inserted into the hole and removed from the hole.

6. An apparatus as recited in claim 1, wherein the hitch stop is capable of sliding onto a trailer hitch tube that is 2 square inches.

7. An apparatus as recited in claim 6, wherein the hitch stop is approximately 0.315 inches thick.

8. An apparatus as recited in claim 7, wherein the difference between the outer square portion and inner square portion is approximately 0.25 inches.

9. An apparatus as recited in claim 8, wherein the hole is 0.25 inches deep.

10. An apparatus as recited in claim 8, wherein the set screw is 0.25 inches long.

11. A method for aligning a trailer hitch tube and a trailer hitch, the method comprising:
placing a hitch stop on a trailer hitch tube, the hitch stop being substantially square and hollow with a hole for a set screw,
inserting the trailer hitch tube into a trailer hitch, the trailer hitch tube and the trailer hitch having hitch pin holes for inserting a hitch pin,
aligning the hitch pin holes,
inserting the hitch pin,
sliding the hitch stop against the trailer hitch,
tightening the set screw.

12. A method as recited in claim 11, further comprising:
removing the trailer hitch tube from the trailer hitch,
reinserting the trailer hitch tube into the trailer hitch with the hitch stop in place,
inserting the hitch pin when the hitch stop aligns the hitch pin holes.

13. A method as recited in claim 11, wherein the trailer hitch tube is approximately 2 square inches.

14. A method as recited in claim 11, wherein the hitch stop is approximately 0.315 inches thick with a border that is approximately 0.25 inches.

15. A method as recited in claim 11, wherein the hitch stop is made from mechanical steel tubing and the set screw is made from stainless steel.

16. A method as recited in claim 11, wherein the hitch stop is made from at least one in the group consisting of the group of steel, rubber and plastic.

17. An apparatus for aligning hitch pin holes, the apparatus comprising:
a hollow, substantially square device that is capable of sliding onto a hitch tube and locking in place when a fastening device that is located in a hole drilled from a circumference of the device to an interior the device is tightened.

18. The apparatus of claim 17, wherein the device is made from mechanical steel tubing and the fastener device is made from stainless steel.

19. The apparatus of claim 17, wherein the dimensions of the device are approximately 2.5×2.5×0.315 inches.

20. The apparatus of claim 17, wherein the device is irremovabley attached to the hitch tube at a location that facilitates alignment of the hitch pin holes.
